(19) United States
(12) Patent Application Publication
(10) Pub. No.: US 2015/0069033 A1
(43) Pub. Date: Mar. 12, 2015

(54) AUXILIARY POWER TAKE OFF FOR ENGINE DRIVEN WELDER

(71) Applicant: LINCOLN GLOBAL, INC., CITY OF INDUSTRY, CA (US)

(72) Inventors: DARREN J. STOCKTON, NEWBURY, OH (US); BRYAN SCOTT BURKHART, CHARDON, OH (US)

(73) Assignee: LINCOLN GLOBAL, INC., CITY OF INDUSTRY, CA (US)

(21) Appl. No.: 14/100,442

(22) Filed: Dec. 9, 2013

Related U.S. Application Data
(60) Provisional application No. 61/876,865, filed on Sep. 12, 2013.

(51) Int. Cl. B23K 9/10

(52) U.S. Cl. CPC B23K 9/1006; B23K 9/1081
USPC 219/133

(57) ABSTRACT

A hybrid power supply for a welder including a controller; an energy storage device electrically connected to the controller to provide power to the controller; an engine having a drive shaft, the engine including a generator adapted to provide power to the controller; a power take off including a transmission having a first portion coupled to the drive shaft and a second portion attachable to an external device; and wherein the controller is adapted to supply power to an implement for a welding operation, the controller regulating the power output from the energy storage device and the engine based on the power required by the implement and the external device.

### CROSS-REFERENCE TO RELATED APPLICATIONS

This application claims the benefit of priority to U.S. Provisional Application Ser. No. 61/876,865, filed Sep. 12, 2013, and entitled “ENGINE DRIVEN POWER SUPPLY.” The entirety of the aforementioned application is incorporated herein by reference.

### TECHNICAL FIELD

The invention described herein pertains generally to an engine driven power supply. More particularly, the invention relates to an engine driver power supply for a welder incorporating a generator.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Traditional welding-type apparatus can be broken into two basic categories. The first category receives operational power from transmission power receptacles, also known as static power. The second is portable or self-sufficient, stand alone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

Static powered welders initiate the weld process by way of a trigger on a hand-held torch or with an electrically charged stick connected to a charged electrode.

Rotating power driven welders operate similarly, as long as the engine is running. If the engine is shut down, there is typically no residual power to create an arc. To once again weld, the engine must be started and run at operational speed to produce the arc. Therefore, it is simply not possible to manually start and stop the engine between each and every break in the welding process. Further, even during longer periods, operators may find it easier to let the engine run because of distance to the engine, a misconception that it is better for the engine, or just out of habit.

### SUMMARY OF THE INVENTION

In accordance with the present invention, there is provided a hybrid power supply for a welder including a controller; an energy storage device electrically connected to the controller to provide power to the controller; an engine having a drive shaft, the engine including a generator adapted to provide power to the controller; a power take off including a transmission having a first portion coupled to the drive shaft and a second portion attachable to an external device; and wherein the controller is adapted to supply power to an implement for a welding operation, the controller regulating the power output from the energy storage device and the engine based on the power required by the implement and the external device.

In accordance with the present invention, there is provided a welding device that includes at least the following: a motor-driven welder assembly including an engine that is a power source for the welding device to perform a welding operation; an energy storage device that provides a supplemental power source to the power source to perform the welding operation; a switch component that is configured to automatically switch between the engine and the energy storage device to perform the welding operation based on a welding parameter; the engine having a drive shaft, the engine including a generator adapted to provide power to a controller; a power take off including a power transmission having a first portion coupled to the drive shaft and a second portion attachable to an external device; wherein the controller is adapted to supply power to an implement for a welding operation, the controller regulating the power output from the energy storage device and the engine based on the power required by the implement and the external device; and a gear box that selectively transmits rotational power from the engine to the external device based upon at least one of a signal from the controller or a user input, wherein the gear box includes at least one set of gears that transmit rotation from the drive shaft of the engine to an angle relative to an axis of the drive shaft.

In accordance with the present invention, there is provided a welding device that includes at least the following: a motor-driven welder assembly including an engine that is a power source for the welding device to perform a welding operation; an energy storage device that provides a supplemental power source to the power source to perform the welding operation; a switch component that is configured to automatically switch between the engine and the energy storage device to perform the welding operation based on a welding parameter; the engine having a drive shaft, the engine including a generator adapted to provide power to a controller; a power take off including a power transmission having a first portion coupled to the drive shaft and a second portion attachable to an external device; wherein the controller is adapted to supply power to an implement for a welding operation, the controller regulating the power output from the energy storage device and the engine based on the power required by the implement and the external device; a gear box that selectively transmits rotational power from the engine to the external device based upon at least one of a signal from the controller or a user input, wherein the gear box includes at least one set of gears that transmit rotation from the drive shaft of the engine to an angle relative to an axis of the drive shaft; and the controller utilizing a dynamically defined threshold that is determined based on a portion of historic data related to one or more welding operations, wherein the historic data includes a detected fault during the one or more welding operations, wherein the dynamically defined threshold is one of a voltage generated by the generator or the energy storage device, a current generated by the generator or the energy storage device, a voltage consumed by the welding operation, a voltage consumed by the external device, a current consumed by the welding operation, and a current consumed by the external device

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of a welder that includes an engine driven power supply;

FIG. 2 is a perspective view of a hybrid welder according to the invention;

FIG. 3 is a perspective view of a welder according to the invention affixed to a trailer for mobility;

FIG. 4A is a perspective view of another hybrid welder according to the invention;

FIG. 4B is a perspective view similar to FIG. 4A rotated 180 degrees with the cover removed to show additional details of the hybrid welder; and

FIG. 5 is a block diagram of a hybrid welder according to the invention with a power take off connected to an external device.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### DETAILED DESCRIPTION OF THE INVENTION

Embodiments of the invention relate to an engine driven power supply. The power supply in the example shown provides power suitable for a welding operation including but not limited to arc welding, gouging, plasma cutting, heating, and the like. It will be appreciated that the power supply of the invention may be used in other power supply applications including portable power generation, backup power generation. Reference to the engine driven power supply being used as an engine driven welder or in connection with a welding operation, herein, should not be considered limiting.

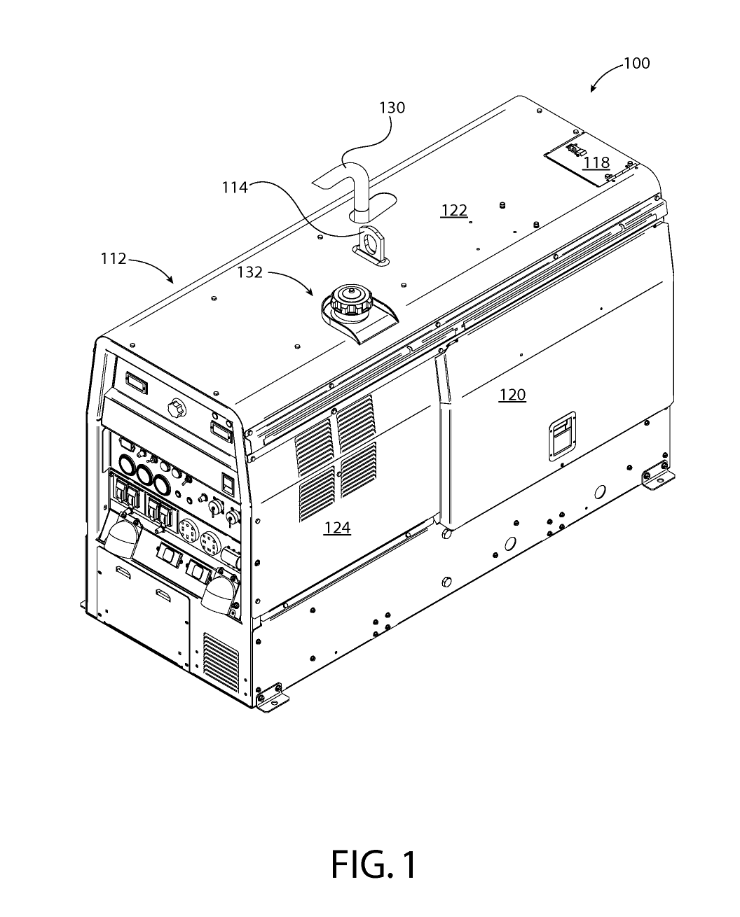

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or batter), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof. It is to be appreciated that a switch component can be configured to automatically switch between the engine (or generator) and the energy storage device to supply power to perform the welding operation. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof

The disclosed power supply of the invention may be used in connection with an engine-driven welder, engine-driven welding system, engine-driven welding apparatus, a welding system powered by an engine alone or in combination with an energy storage device i.e. a hybrid welding power supply. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power.

By way of example and not limitation, FIGS. 1-5 illustrate welding systems or devices that can be utilized with the subject innovation. It is to be appreciated that the following welding systems are described for exemplary purposes only and are not limiting on the welding systems that can utilize the subject innovation or variations thereof.

FIG. 1 illustrates an engine driven welder that can be power supply 100. The power supply 100 includes a housing 112 which encloses the internal components of the welding device. Optionally, the power supply 100 includes a loading eyehook 114 and/or fork recesses 116 to facilitate manipulation and/or transport of the power supply 100. The loading eyehook 114 and the fork recesses 116 facilitate the portability of the power supply 100. Optionally, power supply 100 could include a handle and/or wheels to improve the mobility of power supply 100. The housing 112 may include one or more access panels 118, 120. Access panel 118 provides access to a top portion 122 of housing 112 while access panel 120 provides access to a side portion 124 of housing 112. A similar access panel is available on an opposite side. These access panels 118, 120, provide access to the internal components of the power supply 100 including, for example, an energy storage device (not shown) suitable for providing power for a welding operation. An end panel 126 includes a louvered opening 128 to allow for air flow through the housing 112.

The housing 112 of the power supply 100 also houses an internal combustion engine. To accommodate engine, housing 112 may include an exhaust port 130 and a fuel port 132 that protrude through the housing 112. The exhaust port 130 extends above the top panel 122 of the housing 112 and directs exhaust emissions away from the power supply 100. The fuel port 132 preferably does not extend beyond the top panel 122 or side panel 124. Such a construction protects the fuel port 132 from damage during transportation and operation of the power supply 100. In embodiment, the power supply 100 can be an engine-driven welder, an energy storage device driven welder, a hybrid welding device, or a combination thereof.

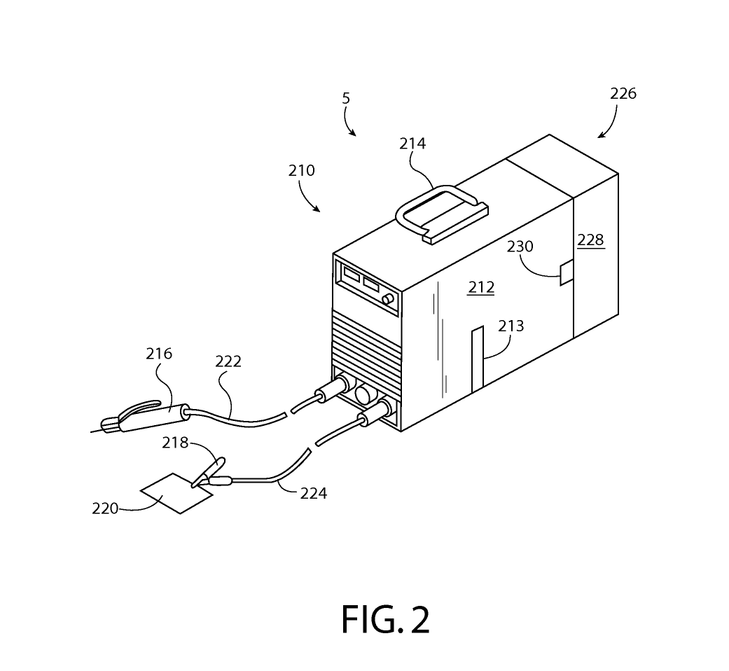

Referring now to FIG. 2, a perspective view of a welding apparatus 5 that can be utilized with the subject innovation. Welding apparatus 5 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular power supply, is produced. Connecting torch 216 and grounding clamp 218 to housing 212 is a pair of cables 222 and 224, respectively.

The welding arc or cutting arc is generated by the power source by conditioning raw power received from an engine 225 and an energy storage device 226. In a preferred embodiment, energy storage device 226 includes one or more batteries. Energy storage device 226 is interchangeable with similarly configured batteries. Specifically, energy storage device 250 is encased in a housing 260. Housing 260 is securable to the housing of welding device 210 thereby forming welding-type apparatus 205. Specifically, energy storage device 250 is secured to power source 210 by way of a fastener 261. It is contemplated that fastener 261 may include a clip, locking tab, screw, bolt, or other means to allow energy storage device 250 to be repeatedly secured and released from power source 210.

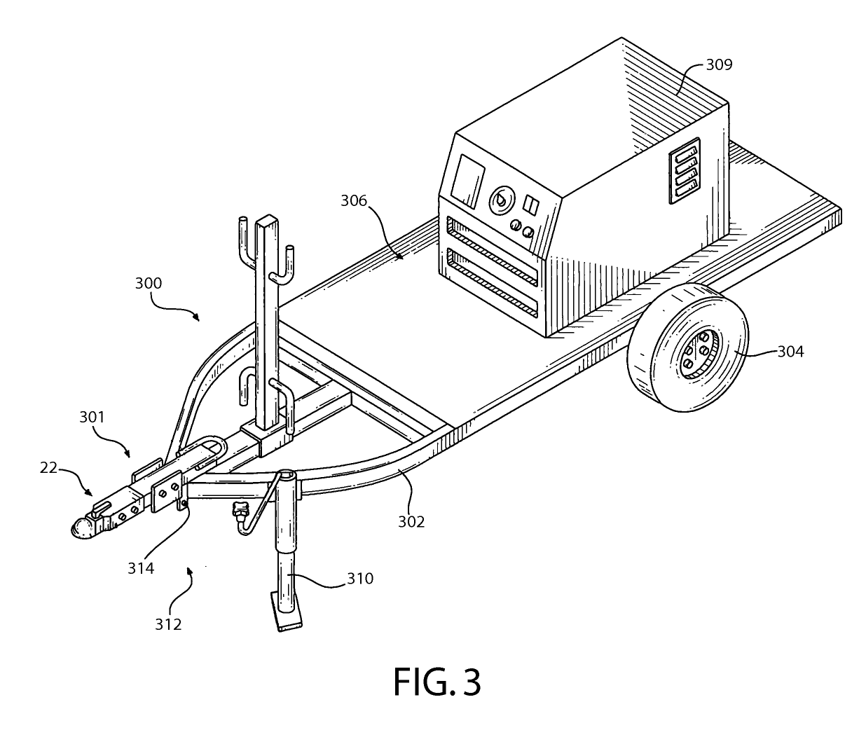

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a power supply 309 for a welder or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

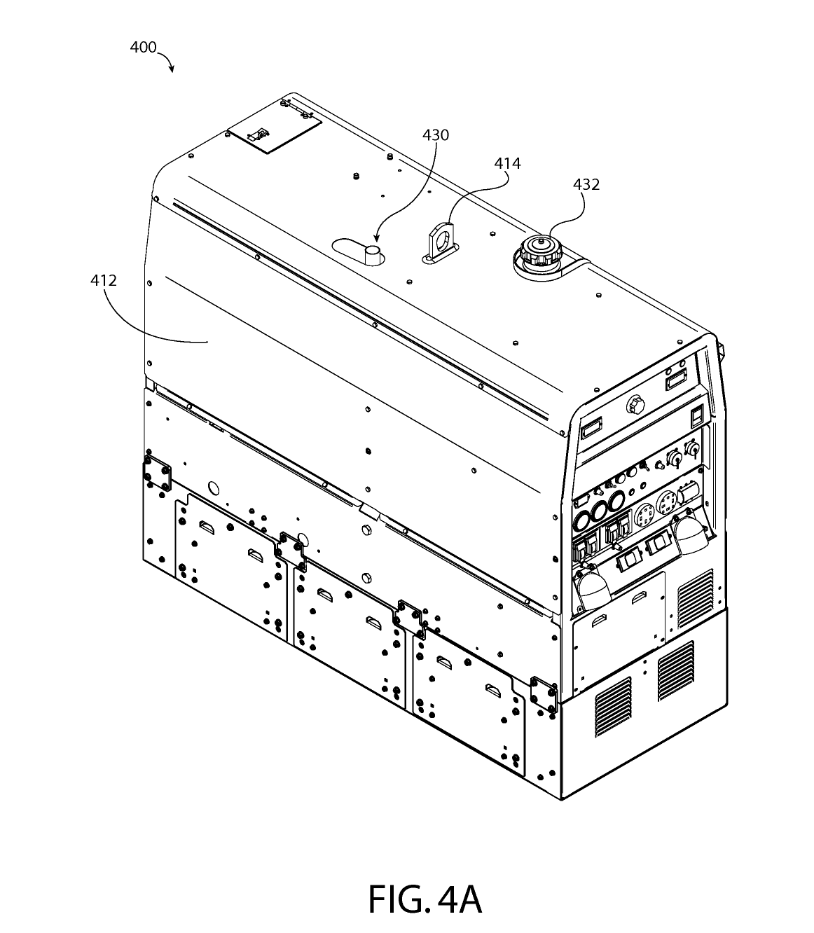

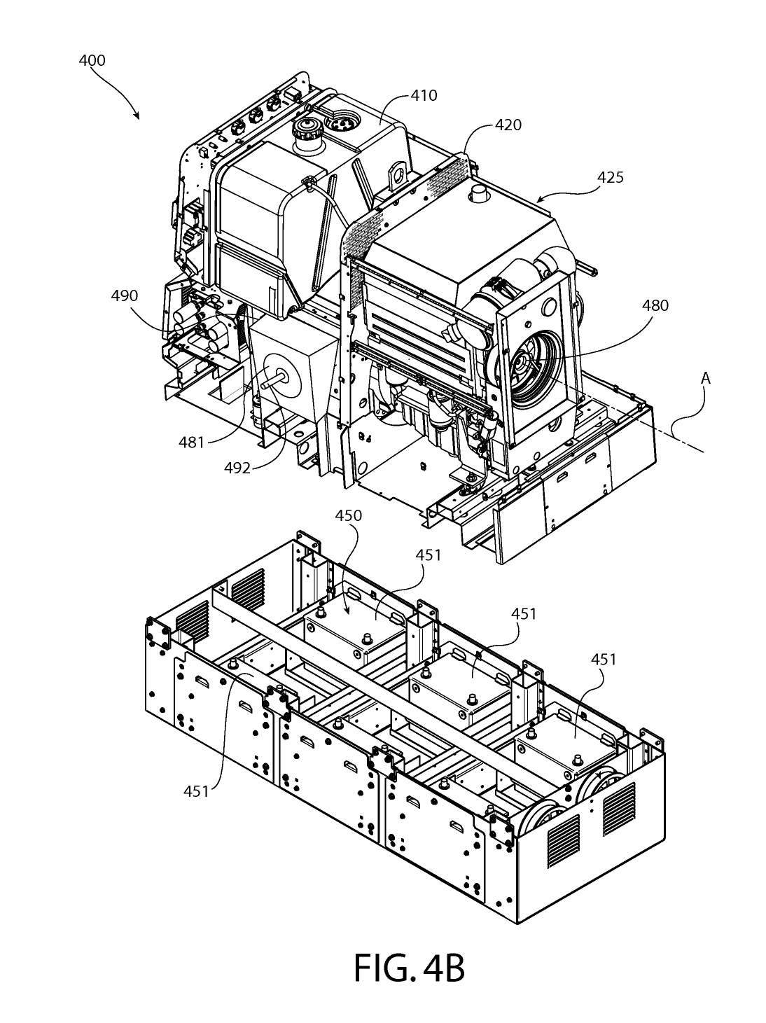

FIGS. 4A and 4B illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes an engine-driven welder assembly 420 having an engine 425 and an energy storage device 450. Engine 425 may be an internal combustion engine operating on any known fuel including but not limited to gasoline, diesel, ethanol, natural gas, hydrogen, and the like. These examples are not limiting as other motors or fuels may be used. In an embodiment, hybrid welder 400 can include an exhaust 430, a loading eyehook 414, and a fuel port 432.

The engine 425 and energy storage device 450 may be operated individually or in tandem to provide electricity for the welding operation and any auxiliary operations performed by hybrid welder 400. For example, individual operation may include operating the engine 425 and supplementing the power from the engine 425 with power from the energy storage device 450 on an as needed basis. Or supplying power from the energy storage device 450 alone when the engine 425 is offline. Tandem operation may also include combining power from engine 425 and energy storage device 450 to obtain a desired power output. According to one aspect of the invention, a welder 400 may be provided with a motor having less power output than ordinarily needed, and energy storage device 450 used to supplement the power output to raise it to the desired power output level. In an embodiment, an engine with no more than 19 kW (25 hp) output may be selected and supplemented with six 12 volt batteries. Other combinations of engine output may be used and supplemented with more or less power from energy storage device. The above example, therefore, is not limiting.

Energy storage device 450 may be any alternative power source including a secondary generator, kinetic energy recovery system, or, as shown, one or more batteries 451. In an embodiment, six 12 volt batteries 451 are wired in series to provide power in connection with engine-driven welder assembly 420. Batteries 451 shown are lead acid batteries. Other types of batteries may be used including but not limited to NiCd, molten salt, NiZn, NiMH, Li-ion, gel, dry cell, absorbed glass mat, and the like.

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 1-5 illustrate a schematic block diagram of a welding device, and in particular, an engine driven welding device as discussed in FIGS. 1-4.

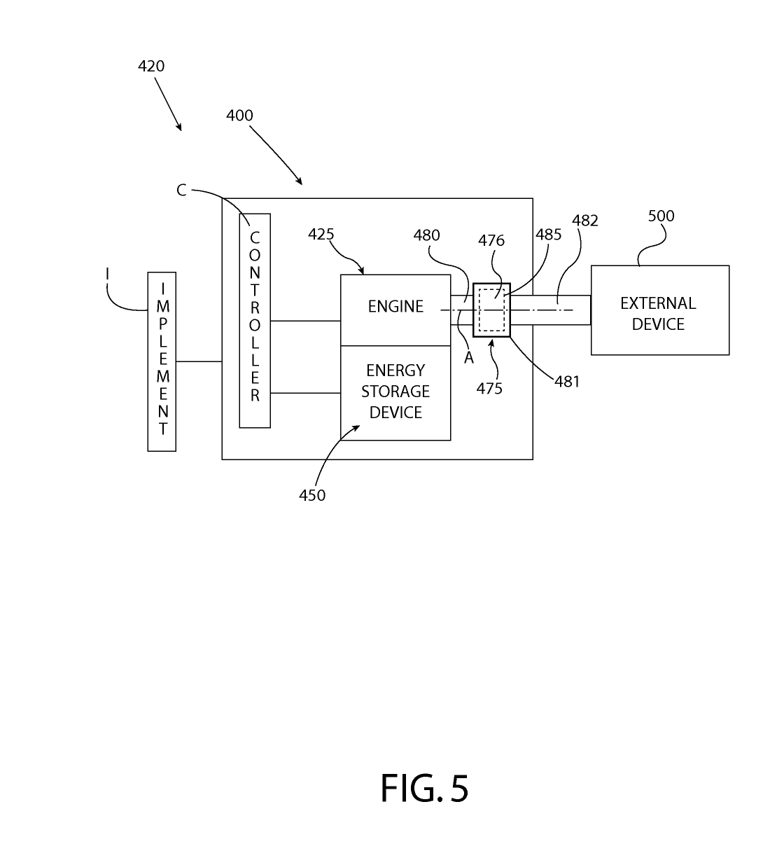

With reference to FIGS. 4 and 5, power supply 400 includes a power take off, generally indicated by the number 475, from the engine 425 to power an external device, generally indicated by the number 500, including but not limited to a hydraulic pump, blower, fume evacuation system, winch, generator, a compressor or other device or implement I (e.g., implement I can be any suitable tool or device that performs a welding operation) that may use the rotational energy of the engine 425. Power take off 475 includes a power transmission 476 that couples the engine 425 and external device 500 to provide power from engine 425 to external device 500. Power transmission 476 may provide a direct or indirect couple between engine 425 and external device 500. For example, power transmission 476 may couple directly to drive shaft 480 of engine 425 or indirectly through the use of a gear box or clutch 485 to selectively transmit rotational motion or energy from engine 425 to the external device 500. Power transmission 476 may include but is not limited to a bolted joint, splined shaft and receiver, gear box, clutch, permanently attached auxiliary shaft or combinations thereof. It will be understood, that a first portion 481 of the power transmission 476 is attached or engaged with engine 425 to receive power from the engine 425 and a second portion 482 is attached or engaged with the external device 500.

In the embodiment shown in FIG. 4B, a 90 degree gear box 490 is provided to transmit rotation from drive shaft of engine 425 to an auxiliary coupler 492 that is oriented perpendicular to the axis A of drive shaft 480. Auxiliary coupler 492 includes a female first portion 481 that may receive a male second portion 482 attached to external device 500. It will be appreciated that other gearing angles may be provide to orient the first portion 481 as desired for a given application. In accordance with another aspect of the invention, the ratio between gears may be equal or unequal depending on the desired rotational speed to be output to the external device 500. It will be appreciated that other methods of setting a desired rotational output shaft speed may be used. Additional transmission devices and couplers may be provided downstream of power take off 475 to adjust the rotational speed and or direction of transmission to accommodate the location of external device. In the example shown, power take off is located on a side of housing 412, and may be provided behind a removable side panel such that when not in use, power take off 475 is shielded by side panel. It is to be further appreciated that the gear box 490 can be oriented in any suitable angle from the axis A of drive shaft 480. For instance, gear box 490 can be configured to be oriented in an angle from 0 to 90 degrees in relation to the axis A of drive shaft 480. In an embodiment, each gear box 490 can include a respective angle that is selected for each specific external device 500. For instance, the gear box 490 can be interchangeable such that a first external device 500 can be used with a first gearbox 490 having a first angle and a second external device 500 can be used with a second gearbox 490 having a second angle. In another embodiment, gearbox 490 can include two or more gear sets that allow for a selectable predetermined (based on the gear set) angle.

In the example shown in FIG. 5, power take off 475 is provided in a position aligned with the axis A of drive shaft 480. This position may extend parallel to drive shaft 480, or, as shown, may extend along the same axis A as drive shaft 480. In the example shown, power transmission 476 is provided directly on drive shaft 480 to transmit rotational energy from drive shaft 480 on a constant basis during operation of engine 425. It will be appreciated that transmission 476 may include a clutch, gear box, or other detachable coupler 485 that allows the user to selectively engage or disengage power take off 475 to transmit rotational energy from engine 425 to external device 500 on an as needed basis. This selective engagement of the power take off 475 may be done manually by the user or automatically through the use of a controller C. The controller C may be the controller for the power source (as shown), the welder, the external device, a separate C controller that is not associated with the devices, or a combination thereof. Controller C can be a portion of hardware, a portion of software, or a combination thereof. For instance, controller C can be a processor and a memory that stores one or more instructions (e.g., data) for execution. In another embodiment, controller C can be a distributed computer architecture that includes one or more controllers (e.g., cloud-based, remote and local system, controller incorporated into power source and external device, among others).

According to another aspect of the invention, controller C manages the power delivery from power source 400 when the power take off 475 is in use. For example, in a hybrid configuration, where an engine 425 and energy storage device 450 may both provide power for the welding operation, controller C can alter the amount of power drawn from energy storage device 450 to make up for the draw of power by the power take off 475 on the engine 425. Controller C may supplement the power from engine 425 with power from energy storage device 450 to make up for any deficiency created by the draw of power take off on engine, or to allow the engine 425 to work at a lower level while maintaining the desired power output to implement I for the welding operation. Extrapolating this, the controller C may draw all of the power necessary for the welding operation from an energy storage device 450 when the power take off 475 is engaged to allow the engine 425 to solely supply power to the power take off 475. Alternatively, when engine 425 is running but no welding operation is underway, controller C may use the power produced by engine 425 to recharge energy storage device 450 or engine 425 may be used solely to power the power take off 475 and the associated external device 500. It will be understood that reference to an external device 500 is not limiting in terms of how the device 500 is mounted or configured with respect to hybrid welder 400. Device 500 may be mounted internally, externally, remotely from hybrid welder 400, or a combination thereof. In an embodiment, external device 500 may be supported on hybrid welder 400.

Controller C is further configured to manage power distribution. In particular, controller C can determine to distribute power from engine 425 and/or energy storage device 450. For instance, controller C can distribute power from power sources (e.g., engine 425, energy storage device 450, or combination thereof) to perform a welding operation or to drive external device 500, wherein the distribution is based upon a parameter. For instance, controller C can, based upon a parameter, distribute power from one or more power sources (e.g., engine 425 and/or energy storage device 450) as follows: distribute power solely to perform a welding operation with via implement I; distribute power to charge energy storage device 450; distribute power to both perform a welding operation and charge energy storage device 450; distribute power solely to external device 500; distribute power to perform a welding operation, charge energy storage device 450, and distribute power to external device 500; or a combination thereof.

Controller C can distribute power from a power source (e.g., energy storage device 450, engine 425, or a combination thereof) to at least one of powering an external device 500, performing a welding operation, or charging energy storage device 450. The following are examples of the parameter that can be evaluated by controller C to identify how to distribute power generated and to where such power should be utilized for consumption.

In an embodiment, the parameter can be a welding parameter. For instance, the welding parameter can be, but is not limited to, a voltage of the welding operation, a current of the welding operation, a welding schedule parameter (e.g., welding process, wire type, wire size, wire feed speed (WFS), volts, trim, a wire feeder to use, feed head to use, among others), a position of a welding tool, a composition of the workpiece on which the welding operation is performed, a position or location of an operator, sensor data (e.g., video camera, image capture, thermal imaging device, heat sensing camera, temperature sensor, among others), a portion of a waveform used for the welding operation, a location on a waveform during progression through a welding operation, a wire feed speed, a type of weld, a workpiece composition, and the like.

In an embodiment, the parameter can be related to a power source (e.g., engine 425, energy storage device 450, or a combination thereof) such as, but not limited to, an amount of fuel available for engine 425, a cost of a fuel for engine 425, a fuel consumption efficiency for engine 425, a duration of time the engine 425 operates, an amount of charge stored in energy storage device 450, a signal from controller C of the welding operation, a signal from a controller associated with implement I, and the like. For instance, a signal from implement I can be from a input device that allows a user to select a manner in which to distribute power. The input device can be, but is not limited to being, a button, a switch, a toggle switch, a knob, an analog knob, a touchpad, a touch screen, a mouse, a mouse button, a keyboard, a keypad, a microphone, a camera, a video camera, a motion sensor, and the like. In general, input device can receive an input from a user or an operator to control power distribution. For instance, the input can be, but is not limited to being, a button activation, a switch activation, a voice command, a motion, a gesture, a hand gesture, an eye movement, a sound, a touch screen input, and the like. In another embodiment, input device is a stand-alone device, incorporated into hybrid welder 400, incorporated into external device 500, or a combination thereof.

In an embodiment, the parameter can be related to external device 500. The parameter can be, but is not limited to being, a type of external device 500, a rating of electrical demand of external device 500 (e.g., needed voltage for operation, needed current for operation, etc.), among others. In an embodiment, the parameter can be a condition external to hybrid welder 400 such as, but not limited to, a geographic location, a temperature, a barometer reading, a humidity level, a weather condition, an altitude, a wind speed, an amount of cloud cover, an weather forecast, an amount of precipitation, and the like.

In another embodiment, controller C can include one or more thresholds to manage distribution of power. For instance, a threshold can be user defined or dynamically defined based on historic data. In an example, a user defined threshold can be set for a power consumption of the external device 500 that upon being reached (e.g., exceeded, met, or fall below), can distribute power to the external device 500 or cease power distribution to the external device 500. In another example, a user defined threshold can be set for an amount of power to be used for a welding operation and that when such threshold is reached, power is to be distributed to perform the welding operation or to cease distribution of power to perform the welding operation. In still another example, a user defined threshold can be set for either the power to perform the welding operation or the power consumption of the external device 500 and upon such threshold being reached a power can be distributed to charge energy storage device 450.

In another embodiment, the welding operation and use of external device 500 can be monitored and one or more thresholds can be dynamically identified and set. For instance, based on a power consumption of the external device 500 or a welding operation, the power needed for the welding operation or the external device 500 may not be met and a fault can occur. The fault can be automatically detected based on a predefined default threshold or based on a user input (e.g., user input identifying a fault occurred due to power distribution). Such fault can be recorded and one or more parameters (e.g., power setting, external device 500 power consumption, engine 425 setting, energy storage device 450 setting, voltage generated by power source, current generated by power source, voltage consumed by welding operation, voltage consumed by external device, current consumed by welding operation, current consumed by external device, and the like) are utilized to set a threshold for a subsequent welding operation. Such evaluated parameter(s) can be used as a threshold (replacing the predefined default threshold) for controlling a power distribution.

In an embodiment, the power transmission is at least one of a bolted joint, splined shaft and receiver, gear box, or clutch. In an embodiment, the subject innovation can further include a gear box that selectively transmits rotational power from the engine to the external device based upon at least one of a signal from the controller or a user input. In an embodiment, the gear box includes at least one set of gears that transmit rotation from the drive shaft of the engine to an angle relative to an axis of the drive shaft. In an embodiment, the angle is 90 degrees.

In an embodiment, the subject innovation can further include the controller distributing power from at least one of the generator or the energy storage device to perform a welding operation or to drive the external device. In an embodiment, the controller distributing power is based upon a welding parameter. In an embodiment, the welding parameter is at least one of a voltage of the welding operation, a current of the welding operation, a wire feed speed, a type of weld, or a workpiece composition. In an embodiment, the welding parameter is at least one of a welding schedule parameter, welding process, wire type, wire size, wire feed speed (WFS), volts, trim, a wire feeder to use, or feed head to use. In an embodiment, the welding parameter is at least one of a position of a welding tool, a composition of the workpiece on which the welding operation is performed, a position or location of an operator, or a portion of sensor data. In an embodiment, the welding parameter is at least one of a portion of a waveform used for the welding operation, or a location on a waveform during progression through a welding operation.

In an embodiment, the subject innovation can further include the controller distributing power from at least one of the generator or the energy storage device to perform a welding operation or to drive the external device based on at least one of an amount of fuel available for engine, a cost of a fuel for engine, a fuel consumption efficiency for engine, a duration of time the engine operates, an amount of charge stored in energy storage device, or a signal from the controller. In an embodiment, the subject innovation can further include the controller distributes power from at least one of the generator or the energy storage device with at least one of the following: distribution of power solely to perform a welding operation; distribution of power to charge the energy storage device; distribution of power to perform a welding operation and charge the energy storage device; distribution of power solely to the external device; or distribution of power to perform a welding operation, charge the energy storage device, and distribute power to the external device. In an embodiment, the external device is at least one of a hydraulic pump, a blower, a fume evacuation system, a winch, a generator, a compressor, or an implement.

In an embodiment, the welding parameter is at least one of a voltage of the welding operation, a current of the welding operation, a wire feed speed, a type of weld, a workpiece composition, a portion of a waveform used for the welding operation, or a location on a waveform during progression through a welding operation. In an embodiment, the external device is at least one of a hydraulic pump, a blower, a fume evacuation system, a winch, a generator, a compressor, or an implement.

In an embodiment, the subject innovation can further include the controller utilizing a dynamically defined threshold that is determined based on a portion of historic data related to one or more welding operations, wherein the historic data includes a detected fault during the one or more welding operations.

In an embodiment, the controller utilizes at least one of the following as the dynamically defined threshold based on the detected fault: a power setting; a power consumption of the external device; a setting of the engine; a setting of the energy storage device; a voltage generated by the generator or the energy storage device; a current generated by the generator or the energy storage device; a voltage consumed by the welding operation; a voltage consumed by the external device; a current consumed by the welding operation; or a current consumed by the external device.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A hybrid power supply for a welder comprising:
a controller;
an energy storage device electrically connected to the controller to provide power to the controller;
an engine having a drive shaft, the engine including a generator adapted to provide power to the controller;
a power take off including a power transmission having a first portion coupled to the drive shaft and a second portion attachable to an external device; and
wherein the controller is adapted to supply power to an implement for a welding operation, the controller regulating the power output from the energy storage device and the engine based on the power required by the implement and the external device.

2. The hybrid power supply for a welder of claim 1, wherein the power transmission is at least one of a bolted joint, splined shaft and receiver, gear box, or clutch.

3. The hybrid power supply for a welder of claim 1, further comprising a gear box that selectively transmits rotational power from the engine to the external device based upon at least one of a signal from the controller or a user input.

4. The hybrid power supply for a welder of claim 3, wherein the gear box includes at least one set of gears that transmit rotation from the drive shaft of the engine to an angle relative to an axis of the drive shaft.

5. The hybrid power supply for a welder of claim 4, wherein the angle is 90 degrees.

6. The hybrid power supply for a welder of claim 1, further comprising the controller distributing power from at least one of the generator or the energy storage device to perform a welding operation or to drive the external device.

7. The hybrid power supply for a welder of claim 6, wherein the controller distributing power is based upon a welding parameter.

8. The hybrid power supply for a welder of claim 7, wherein the welding parameter is at least one of a voltage of the welding operation, a current of the welding operation, a wire feed speed, a type of weld, or a workpiece composition.

9. The hybrid power supply for a welder of claim 7, wherein the welding parameter is at least one of a welding schedule parameter, welding process, wire type, wire size, wire feed speed (WFS), volts, trim, a wire feeder to use, or feed head to use.

10. The hybrid power supply for a welder of claim 7, wherein the welding parameter is at least one of a position of a welding tool, a composition of the workpiece on which the welding operation is performed, a position or location of an operator, or a portion of sensor data.

11. The hybrid power supply for a welder of claim 7, wherein the welding parameter is at least one of a portion of a waveform used for the welding operation, or a location on a waveform during progression through a welding operation.

12. The hybrid power supply for a welder of claim 1, further comprising the controller distributing power from at least one of the generator or the energy storage device to perform a welding operation or to drive the external device based on at least one of an amount of fuel available for engine, a cost of a fuel for engine, a fuel consumption efficiency for engine, a duration of time the engine operates, an amount of charge stored in energy storage device, or a signal from the controller.

13. The hybrid power supply for a welder of claim 1, further comprising the controller distributes power from at least one of the generator or the energy storage device with at least one of the following: distribution of power solely to perform a welding operation; distribution of power to charge the energy storage device; distribution of power to perform a welding operation and charge the energy storage device; distribution of power solely to the external device; or distribution of power to perform a welding operation, charge the energy storage device, and distribute power to the external device.

14. The hybrid power supply for a welder of claim 1, wherein the external device is at least one of a hydraulic pump, a blower, a fume evacuation system, a winch, a generator, a compressor, or an implement.

15. A welding device, comprising:
a motor-driven welder assembly including an engine that is a power source for the welding device to perform a welding operation;
an energy storage device that provides a supplemental power source to the power source to perform the welding operation;
a switch component that is configured to automatically switch between the engine and the energy storage device to perform the welding operation based on a welding parameter;
the engine having a drive shaft, the engine including a generator adapted to provide power to a controller;
a power take off including a power transmission having a first portion coupled to the drive shaft and a second portion attachable to an external device; wherein the controller is adapted to supply power to an implement for a welding operation, the controller regulating the power output from the energy storage device and the engine based on the power required by the implement and the external device; and
a gear box that selectively transmits rotational power from the engine to the external device based upon at least one of a signal from the controller or a user input, wherein the gear box includes at least one set of gears that transmit rotation from the drive shaft of the engine to an angle relative to an axis of the drive shaft.

16. The welding device of claim 15, wherein the welding parameter is at least one of a voltage of the welding operation, a current of the welding operation, a wire feed speed, a type of weld, a workpiece composition, a portion of a waveform used for the welding operation, or a location on a waveform during progression through a welding operation.

17. The welding device of claim 15, wherein the external device is at least one of a hydraulic pump, a blower, a fume evacuation system, a winch, a generator, a compressor, or an implement.

18. The welding device of claim 15, further comprising the controller utilizing a dynamically defined threshold that is determined based on a portion of historic data related to one or more welding operations, wherein the historic data includes a detected fault during the one or more welding operations.

19. The welding device of claim 18, wherein the controller utilizes at least one of the following as the dynamically defined threshold based on the detected fault: a power setting; a power consumption of the external device; a setting of the engine; a setting of the energy storage device; a voltage generated by the generator or the energy storage device; a current generated by the generator or the energy storage device; a voltage consumed by the welding operation; a voltage consumed by the external device; a current consumed by the welding operation; or a current consumed by the external device.

20. A welding device, comprising:
a motor-driven welder assembly including an engine that is a power source for the welding device to perform a welding operation;
an energy storage device that provides a supplemental power source to the power source to perform the welding operation;
a switch component that is configured to automatically switch between the engine and the energy storage device to perform the welding operation based on a welding parameter;
the engine having a drive shaft, the engine including a generator adapted to provide power to a controller;
a power take off including a power transmission having a first portion coupled to the drive shaft and a second portion attachable to an external device; wherein the controller is adapted to supply power to an implement for a welding operation, the controller regulating the power output from the energy storage device and the engine based on the power required by the implement and the external device;
a gear box that selectively transmits rotational power from the engine to the external device based upon at least one of a signal from the controller or a user input, wherein the gear box includes at least one set of gears that transmit rotation from the drive shaft of the engine to an angle relative to an axis of the drive shaft; and
the controller utilizing a dynamically defined threshold that is determined based on a portion of historic data related to one or more welding operations, wherein the historic data includes a detected fault during the one or more welding operations, wherein the dynamically defined threshold is one of a voltage generated by the generator or the energy storage device, a current generated by the generator or the energy storage device, a voltage consumed by the welding operation, a voltage consumed by the external device, a current consumed by the welding operation, and a current consumed by the external device.
